(19) United States
(12) Patent Application Publication
(10) Pub. No.: US 2016/0324705 A1
(43) Pub. Date: Nov. 10, 2016

(54) SAFETY DEVICE FOR AN AUXILIARY WHEELCHAIR ELEMENT

(71) Applicant: BATEC MOBILITY, S.L., Barcelona (ES)

(72) Inventor: Pablo Alejandro BACH CASTILLO, Barcelona (ES)

(21) Appl. No.: 14/903,299

(22) PCT Filed: Jul. 8, 2014
(86) PCT No.: PCT/ES2014/070554

§ 371 Date: Jan. 7, 2016

(30) Foreign Application Priority Data
Jul. 8, 2013 (ES) U201330858

(51) Int. Cl. A61G 5/10; A61G 5/12

(52) U.S. Cl. CPC A61G 5/10; A61G 5/12; A61G 5/027

(57) ABSTRACT

The invention relates to a safety device for an auxiliary wheelchair element, said auxiliary element being of the type used to convert a wheelchair into a chair in the form of a tricycle or similar. The device comprises a frame that is connected to the auxiliary element, said frame being formed by bars and two segments with different inclinations. The bars are connected by means for protecting and means for covering the lower limbs and the soles of the feet of a disabled person using a wheelchair with such an auxiliary element, as well as covering and protecting the wheelchair against possible irregularities and/or obstacles on the ground, and additionally ensuring that the auxiliary wheelchair element rests on the ground in the upright position when not in use.

### OBJECT OF THE INVENTION

The present invention application is intended to register a safety device for an auxiliary wheelchair element that includes considerable improvements and advantages with regard to the techniques used until now.

More specifically, the invention proposes the development of a safety device for an auxiliary wheelchair element, that given its particular arrangement makes it possible to provide added protection and covering to the lower limbs and the soles of the feet of a disabled person using a wheelchair fitted with such an auxiliary element, as well as protecting and covering the wheelchair itself against possible irregularities and/or obstacles on the ground, and additionally ensuring that the auxiliary wheelchair element rests on the ground in the upright position when not in use.

### BACKGROUND OF THE INVENTION

In the present state of the art, various auxiliary elements are known that are devised and conceived of to be used in a wheelchair, in the sense that they make it possible to transform a traditional wheelchair into a chair in the form of a tricycle, with the advantageous benefits that this involves.

Despite the undoubted benefits and advantages provided by such auxiliary elements to a wheelchair, their use involves a potential danger for the lower limbs of the disabled people using wheelchairs fitted with the auxiliary element, due to the low level of control that such people can exercise over their lower limbs.

As a consequence of this, for example, the presence of a third central wheel of the auxiliary element fitted to the wheelchair could lead to the user inadvertently inserting their feet between the spokes of the wheel, or also contact with external agents such as water, sand, gravel, stones or others that could be kicked up by the front wheel as an effect of its operation.

Another aspect that could be improved regarding their protection is the soles of the feet of the user, especially in the case of ground that is rough and irregular and/or contains obstacles.

Also, while using the wheelchair fitted with such an auxiliary element, sometimes it is necessary to shield some parts of the wheelchair itself, such as the footplates, from any irregularities and/or obstacles on the ground, such as going up or down a curb, or stones, sticks, plants, etc.

Furthermore, when such auxiliary elements are not being used, it is necessary to provide the means for appropriate upright positioning, so as to avoid a possible negligent situation and poor placement on the floor when not in use.

The present invention helps solve and overcome the present set of problems, offering appropriate protection to the lower limbs of the user of the wheelchair against the auxiliary element fitted to this same wheelchair, as well as the soles of the feet, and in covering the wheelchair itself while moving along the terrain, also enabling appropriate placement in the upright position on the floor when said auxiliary element is not in use.

### DESCRIPTION OF THE INVENTION

The present invention has been developed in order to provide a safety device for an auxiliary wheelchair element, said auxiliary element being of the type used to convert a wheelchair into a chair in the form of a tricycle or similar, and it is essentially characterized in that it comprises a frame connected to the auxiliary element, said frame being formed by bars and two segments with different inclinations. The bars are connected by means for protecting and means for covering.

Preferably, in the safety device for an auxiliary wheelchair element, the means for protecting comprise at least one plate acting as a screen, fixed to the inner space delimited by the bars in one of the sections.

Additionally, in the safety device for an auxiliary wheelchair element, the means for covering include a base in the inner space delimited by the bars in another section.

Alternatively, the safety device for an auxiliary wheelchair element comprises support means.

Also, in the safety device for an auxiliary wheelchair element, the support means are formed by wheels connected to the ends of the frame bars.

In the same way, the safety device for an auxiliary wheelchair element comprises lighting means.

Preferably, in the safety device for an auxiliary wheelchair element, the lighting means take the form of LEDs located on the frame.

Additionally, in the safety device for an auxiliary wheelchair element, the frame has a perceptibly rectangular geometry.

Alternatively, in the safety device for an auxiliary wheelchair element, the means for protecting and the means for covering are integrated.

As a result of the present invention, appropriate and effective protection for the lower limbs of the disabled people using the wheelchair is achieved against possible harm caused by the presence of the auxiliary element fitted to this same wheelchair, as well as the soles of the feet, due to the low level of control that such people can exercise over their lower limbs, as well as covering the wheelchair while moving across the ground against any irregularities and/or obstacles, while also improving its cleanliness in a similar way to a mudguard.

Another improvement is reducing the minimum distance between the chair and the added central wheel, which contributes to improving the traction of said added central wheel, especially in the case of ramps, slippery surfaces, etc.

Furthermore, an appropriate upright positioning on the ground can be provided when said auxiliary element is not in use.

Other characteristics and advantages of the safety device for an auxiliary wheelchair element will become clear in the light of the description of a preferred though non-exclusive embodiment, which by way of a non-limiting example is illustrated in the accompanying drawings, wherein:

### BRIEF DESCRIPTION OF THE DRAWINGS

FIGS. 1 and 2. These are some schematic views from different perspectives of a preferred embodiment of the safety device for an auxiliary wheelchair element of the invention.

### DESCRIPTION OF A PREFERRED EMBODIMENT

As illustrated in the figures, the safety device for an auxiliary wheelchair element, said auxiliary element being of the type used to convert a wheelchair into a chair in the form of a tricycle or similar, comprises a frame 1 connected to the auxiliary element, said frame 1 being formed by bars 11 and two segments 12, 13 with different inclinations. The bars 11 are connected by means for protecting and means for covering.

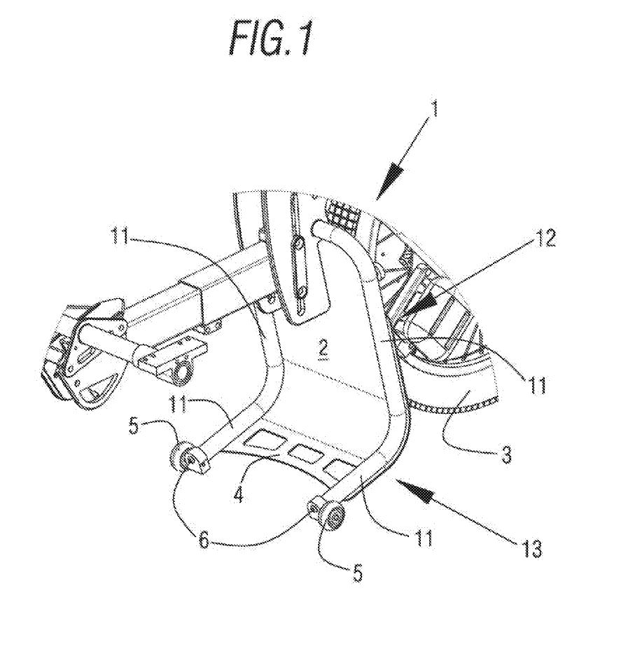

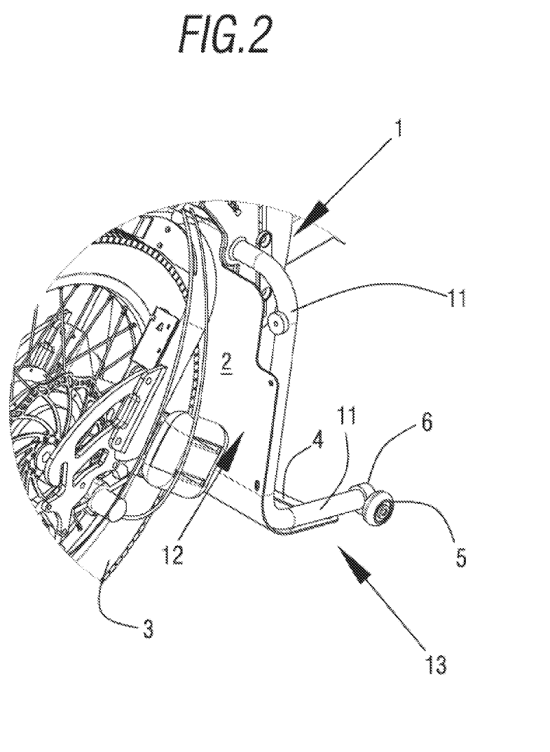

In this preferred embodiment schematically illustrated in FIGS. 1 and 2, the frame 1 has a perceptibly rectangular layout and is connected to the auxiliary wheelchair element in the area of this element which is close to the wheel 3 of the auxiliary element itself.

The frame 1 is formed by bars 11, forming two sections 12, 13 with different inclinations, as shown especially in FIG. 1.

In this preferred embodiment, the means for protecting are formed by a rigid plate 2 framed in the inner space delimited by bars 11 in the section 12.

This plate 2 provides protection to the lower limbs of the disabled people using the wheelchair, against possible harm caused by the auxiliary element fitted to the wheelchair, which could be caused, for example, by the presence of the third central wheel 3 present in the fitted auxiliary element, such as the feet being caught between the spokes of wheel 3, for example.

In this preferred embodiment, the means for covering are formed by a base 4 framed in the inner space delimited by the bars 11 in the section 13.

With the means for protecting and means for covering, the wheelchair itself is also protected, for example the footplates, from impact when going up or down a curb, or from stones, sticks, plants, etc. as it moves across an irregular area, for example.

The safety device for an auxiliary wheelchair element of the present invention in this preferred embodiment comprises ground support means, which are formed by wheels 5 inserted in ends of the bars 11 that form the frame 1.

The support of such wheels 5 on the ground, along with the wheel 3 of the auxiliary element, allows for appropriate upright positioning on the ground of the auxiliary element when said auxiliary element is not in use.

In this preferred embodiment, the safety device for an auxiliary wheelchair element of the invention also comprises lighting means, formed by 6 LEDs located on the frame 1, in a position adjacent to the wheels 5, and aiming in the direction opposite to the forward direction of the wheelchair fitted with the auxiliary element.

With this, the light provided by these 6 LEDs contributes to improving the safety of the wheelchair while in motion, and makes its movement more visible, especially in situations of low ambient light. In this preferred embodiment the 6 LEDs emit a red light, which is visible by other users of the street, although in other embodiments another color may be used.

In another preferred embodiment, the means for protecting and the means for covering can be integrated into one continuous piece.

The proposed invention provides the necessary protection for the lower limbs of the disabled people using the wheelchair against the auxiliary element fitted to the wheelchair, as the result of the limited control they can exercise over these limbs, also improving its cleanliness in a similar way to a mudguard, thus avoiding contact with agents such as water, sand, gravel, stones or others that could be kicked up by the front wheel as it operates.

Appropriate protection for the soles of the feet is also achieved, especially when moving across ground that is irregular and/or contains obstacles that could put the user in danger.

Furthermore, the protection also extends to the wheelchair itself, such as the footplates, against possible impact due to irregularities of the ground or obstacles present therein.

Also, the distance between the wheelchair and the added central wheel can be reduced, thus improving the traction and adherence of said added central wheel, especially in the case of ramps, slippery surfaces, etc.

Furthermore, a useful aid is provided for the appropriate upright positioning of said auxiliary element when it is not in use, thus avoiding a possible negligent situation and poor positioning on the floor when not in use.

The proposed invention can also provide positive benefits regarding the improvement of visibility of the wheelchair as it moves, especially in situations of low ambient light.

The details, shapes, dimensions and other accessory elements, as well as the materials used to manufacture of the safety device for an auxiliary wheelchair element of the invention, may be suitably substituted for others that are technically equivalent, and do not diverge from the essential nature of the invention, nor the scope defined by the claims included below.

What is claimed is:

1. A safety device for an auxiliary wheelchair element, said auxiliary element being of the type used to convert a wheelchair into a chair in the form of a tricycle or similar, characterized in that it comprises a frame (1) that is connected to the auxiliary element, said frame (1) being formed by bars (11) and two segments (12, 13) with different inclinations, the bars (11) being connected by means for protecting and means for covering.

2. The safety device for an auxiliary wheelchair element according to claim 1, characterized in that the means for protecting comprise at least one plate (2) acting as a screen, fixed to the inner space delimited by the bars (11) in the section (12).

3. The safety device for an auxiliary wheelchair element according to claim 1, characterized in that the means for covering comprise a base (4) in the inner space limited by the bars (11) in the section (13).

4. The safety device for an auxiliary wheelchair element according to claim 1, characterized in that it comprises support means.

5. The safety device for an auxiliary wheelchair element according to claim 4, characterized in that the support means are formed by wheels (5) connected to ends of the bars (11) of the frame (1).

6. The safety device for an auxiliary wheelchair element according to claim 1, characterized in that it comprises lighting means.

7. The safety device for an auxiliary wheelchair element according to claim 6, characterized in that the lighting means are formed by LEDs (6) located on the frame (1).

8. The safety device for an auxiliary wheelchair element according to claim 1, characterized in that the frame (1) has a perceptibly rectangular geometry.

9. The safety device for an auxiliary wheelchair element according to claim 1, characterized in that the means for protecting and the means for covering are integrated.
